(19) United States
(12) Patent Application Publication
(10) Pub. No.: US 2017/0232444 A1
(43) Pub. Date: Aug. 17, 2017

(54) Tool Assembly for A Comminuting Apparatus

(71) Applicant: VECOPLAN AG, Bad Marienberg (DE)

(72) Inventors: Wolfgang Lipowski, Seck (DE); Markus Claudy, Wetzlar (DE)

(21) Appl. No.: 15/392,902

(22) Filed: Dec. 28, 2016

(30) Foreign Application Priority Data
Dec. 29, 2015 (DE) 20 2015 107 131.0

(51) Int. Cl. B02C 18/18

(52) U.S. Cl. CPC B02C 18/18; B02C 2210/02

(57) ABSTRACT

A tool assembly for a comminuting apparatus having knives secured to the periphery of a comminuting rotor is provided including an integral knife carrier adapted to be secured to the comminuting rotor of the comminuting apparatus having a supporting surface for support against a seat formed at the rotor and an abutment face with a non-threaded through bore extending therefrom. The assembly includes a knife detachably secured to the knife carrier, a screw connection between the knife and knife carrier, and a screw bolt extending through the through bores of the knife and the knife carrier, wherein a screw nut is screwed onto a portion of the screw bolt extending beyond a trough bore of the knife carrier for clamping the knife to the knife carrier.

The invention relates to a tool assembly for a comminuting apparatus for comminuting material to be comminuted such as refuse and/or production residues, comprising an integral knife carrier and a knife detachably secured to the knife carrier. The invention also relates to a comminuting rotor, comprising such a tool assembly and a knife for such a tool assembly.

In the comminuting apparatus described herein, the knives secured to the periphery of a comminuting rotor usually act together with counter knives disposed stationarily with respect to the rotor, e.g. at the machine part of the comminuting apparatus, to comminute material to be comminuted, such as wood, paper, plastics, rubber, textiles, production residues or waste from industry and commerce, but also bulky waste, domestic waste and DSD collections, such as hospital waste, etc. Depending on the material to be comminuted, especially the knives disposed at the comminuting rotor are subject to significant wear, making it necessary to replace such knives regularly depending on the given material to be comminuted. To this end, the knives are detachably secured to the comminuting rotor through a respective knife carrier. In turn, the knife carrier is coupled to the comminuting rotor, e.g. using screws or by welding.

It is known to fasten the knives, also known in the art as cutting crowns, using a respective screw connection between the knife and knife carrier, wherein a screw bolt extends at the rear through a through bore in the knife carrier, the bolt being screwed into a threaded bore extending between both bases of the knife and aligned with the though bore in the knife carrier.

To reduce wear, the cutting crowns are made of high-alloy tool steel and/or hardened after shaping. Conventional cutting crowns have a maximum hardness of about 59 HRC. Nevertheless, fractures or chipping of the knives may sometimes occur due to heavy stresses on the knives during the comminuting process, e.g. caused by impurities in the material to be comminuted. What is problematic is that the thread root of the threaded bore in the knives acts as a stress concentrator which may cause the knives to break. In addition, shell-like chipping may occur during operation in the area of the threaded bore of the knife on the side facing the knife carrier. Choosing a tool steel of even greater hardness for the knife to increase wear resistance was shown to be ineffective as this actually reduces the service life of the knives due to an increased fracturing risk.

The object of the invention is to increase the service life of conventional knives for comminuting apparatus. This object is achieved, according to the invention, by a tool assembly for a comminuting apparatus having knives secured to the periphery of a comminuting rotor, comprising the features of claim 1.

The tool assembly of the invention has a preferably integral knife carrier able to be secured to the comminuting rotor of the comminuting apparatus, and having a supporting surface for support against a seat formed at the rotor and an abutment face with a non-threaded through bore extending therethrough. The tool assembly further comprises a knife detachably secured to the knife carrier, having at least three, in particular four, lateral boundary faces and two bases, wherein at least one of the two bases is adapted to be a working face having a plurality of cutting edges, and wherein two cutting edges intersect at a cutting tip. The knife has a non-threaded through bore extending between both bases and having a countersink in the form of a conical expansion at the working face. When installed, the knife directly or indirectly abuts the abutment face of the knife carrier with one of its two bases, wherein the through bores of the knife carrier and the knife are aligned to each other and a screw connection is provided between the knife and knife carrier, comprising a screw bolt extending through the through bores of the knife and the knife carrier with a conical head abutting, or being received by, the countersink of the bore at the working face of the knife. In order to secure the knife to the knife carrier, a screw nut having a sleeve-like base body is screwed onto a portion of the screw bolt extending beyond the through bore of the knife carrier.

The specified configuration of the tool assembly of the invention and/or the configuration of the knife and the associated knife carrier allow to provide a fastening of the knife which is associated with lower mechanical stresses on the knife compared to those of known knives, thereby increasing the average service life of the knife of the tool assembly of the invention. By not using a thread in the knife, the stress concentrations particularly occurring there due to operating forces acting on the hardened material or high-ally tool steel can be avoided. Ultimately, the configuration of the invention also allows to avoid the solution of inserting a threaded sleeve into a corresponding through bore within the knife which may be practised in the art, since inserting such a threaded sleeve into the knife is associated with a larger bore, i.e. with a greater weakening of the material, and therefore reduced service life of the knife.

In addition, in the tool assembly of the invention, the holding forces required to secure the knife to the knife carrier can be symmetrically introduced into the knife across the entire conical expansion at the working face of the knife so as to eliminate or reduce local peak stresses at or within the knife which would otherwise decrease the knife's service life. Not using a thread within the knife also eliminates any asymmetrical distribution of the preload force of the screw bolt within the thread due to a possible difference in degrees of hardness between the knife and screw bolt, substantially reducing the often shell-like chipping on the knife as described above.

The configuration of the tool assembly of the invention and/or the knife and the associated knife carrier allows to considerably increase the degree of hardness of the knife material and thus the service life of the knife compared to those of conventional knives without increasing the risk of fractures and chipping on the knife as with the known tool assemblies or knives. Thus, the invention now enables the knives to be designed using high-alloy tool steels with degrees of hardness of a Rockwell hardness of greater than 59 HRC, in particular a Rockwell hardness of about 62 HRC or even a Rockwell hardness of greater than 62 HRC, such as 63 HRC. Ultimately, the invention now also allows to form the knives as solid hard metal knives instead of from high-ally tool steel, thereby extremely reducing wear of the knives compared to conventional configurations of the tool assembly or knife and substantially increasing the service life even further. Such hard metals may comprise or consist of cemented compound materials such as cemented carbide hard metals.

Other features of the invention will become apparent from the general and specific description, the figures and the dependent claims.

In order to enhance the knife's impact on the material to be comminuted and thus in particular increase throughput, the at least one working face of the knife may conveniently be formed concavely to provide curved cutting edges. Thus, portions of the base and/or working face are bulged inwardly such that the respective two cutting edges intersecting at a cutting tip are concave. This creates a cutting tip which extends towards the material to be comminuted and enters the cutting material like a hook, wherein, as the cutting process continues, the two cutting edges intersecting at the cutting tip act on the material to comminute it.

Conveniently, the knife may be configured as a prism having four lateral faces and two bases, wherein, in the general embodiment of the knife, when connected to the knife carrier, the base adapted to be the working face may provide the geometry acting on the material to be comminuted, and the second base may provide an abutment face for abutting an associated abutment face of the knife carrier.

When configuring the knife of the tool assembly of the invention to have four lateral faces or four cutting edges on each base, four cutting tips may conveniently be provided. Thus, upon wear of a cutting tip or its associated cutting edges intersecting at the cutting tip, an unused cutting tip and associated unused cutting edges are available for another comminuting cycle between servicing intervals by unscrewing the screw connection and turning the knife by 180° about the bore axis. Conveniently, the knife may be secured to the knife carrier such that only the two cutting edges of the working face intersecting at a cutting edge are exposed and the other two edges of the working face are covered or protected by being seated against the comminuting rotor. For example, the knife along with the knife carrier may be inserted into a respective seat at the rotor with one knife tip facing upwards, wherein the seat may have the form of a V-shaped recess, such that the two cutting edges which are non-active due to the installation position of the knife are disposed in the V-shaped recess and thus protected.

To further increase the service life of a knife, it may be contemplated to also form the other base of the knife as a working face having a plurality of cutting edges, wherein, for example, respective two cutting edges intersect at a cutting tip, and the bore has a conical expansion at the other base. This embodiment may therefore provide both a working face and an abutment face on both bases, depending on the position of the knife relative to the knife carrier. To switch working faces, the knife is detached from the knife carrier by unscrewing and removing the screw bolt, inverted and then secured abutting the knife carrier with the other base. By correspondingly configuring both bases as a working face, multiple cutting tips and associated cutting edges can then in turn be provided by rotating the knives about the bore axis.

Conveniently, if both bases are configured as working faces with corresponding cutting edges, these may be structured identically. However, in another embodiment, they can also be configured differently, for example with a different degree of concavity corresponding to different radii of curvature of the working faces or cutting edges. By selecting the respective working face of the knife, it may, for example, be adapted to different comminuting requirements or different materials to be comminuted.

In particular, the tool assembly of the invention can be used for replacing a conventional knife carrier with an associated knife with the advantages described above. This particularly applies to such knife carriers which are able to be secured to the comminuting rotor through a detachable connection. The securing means at the knife carrier of the tool assembly may be adapted to the respective comminuting rotor. However, in a particular embodiment, it may also be contemplated to weld the knife carrier of the tool assembly of the invention onto the comminuting rotor.

Conveniently, it may be contemplated that the screw bolt abuts the knife only with its conical head such that, when clamping the knife to the knife carrier, the flow of forces within the knife is as symmetrical as possible.

To protect the screw nut, in particular from mechanical impacts, it may be contemplated that the knife carrier has a cylindrical depression around its bore at the side facing away from the knife, with at least a portion of the screw nut extending axially into such depression.

Further protection from mechanical impacts of material to be comminuted on the connection point between nut and screw bolt can be achieved by at least one boundary face of the knife carrier shadowing the threaded end of the screw bolt in the rotor's direction of movement, in particular including the screw nut.

To particularly ensure easy detachment of the screw connection between knife and knife carrier, it may conveniently be contemplated that a positive-fit anti-rotation mechanism is provided between the shaft of the screw bolt and the knife carrier. This may conveniently be achieved using various configurations. For example, the shaft of the screw bolt may have a polygonal configuration extending axially over a predetermined distance in the cross section, and the bore of the knife carrier within this longitudinal portion may be of a complementary polygonal shape to provide a positive fit between the screw bolt and knife carrier. In another embodiment, a key or close tolerance pin may be disposed, each extending in a keyway or mating bore, respectively, within the screw bolt and knife carrier. All of these embodiments have in common that a tangential force onto the screw bolt can be absorbed by the knife carrier.

For the screw connection to be able to be unscrewed even after prolonged use of the knife despite operating forces acting on the entire tool assembly, in particular from moving material to be comminuted, it may be contemplated that the screw nut has a sleeve-like base body. This sleeve-like base body may comprise an internal threaded portion and a tool-engaging portion axially adjacent thereto directly or via an axial connecting portion, wherein the tool-engaging portion may have an axial mount for providing tool abutment faces, in particular in the form of a hexagon socket. This axial mount may in particular be defined by the described tool abutment faces which may extend in axial direction. Since a comminuting rotor usually rotates into a predetermined and non-changing direction, the tool abutment faces are optimally protected without increased forces acting upon them during the comminuting operation. It could only be that deposits may have to be removed from the axial mount, for example using compressed air to clear the tool abutment faces disposed in the axial mount.

In a particular embodiment, it may be contemplated that, between the axially extending threaded portion and the axially extending tool-engaging portion of the screw nut, a bottom portion is disposed which extends radially to the axis of the sleeve-like base body such that the end of the threaded bolt screwed into the screw nut is hermetically covered, in particular preventing any impact of material to be comminuted on the thread of the threaded bolt.

The knife may abut an abutment face of the knife carrier with one of both bases either directly or indirectly, e.g. via an intermediate plate. This abutment face of the knife carrier may, in particular, be configured as a flat surface. In such cases, in which the abutment face of the knife is not configured to be flat against the knife carrier, but at least partially curved, e.g. concave, the abutment face of the knife carrier may be configured to correspond to the curvature of the knife's base, e.g. convex. This particularly applies to such knives having concave cutting edges on both bases.

In a particular implementation, an adapter plate may be disposed between the knife carrier and knife to adapt the abutment face of the knife to the abutment face of the knife carrier.

In addition, the invention comprises a comminuting rotor for a comminuting apparatus having at least one, usually a plurality of, tool assemblies as claimed in any one of claims 1 to 13.

Furthermore, the invention comprises a knife for a tool assembly as claimed in any one of claims 1 to 13.

The invention will now be illustrated by describing several embodiments with reference to the appended drawings in which

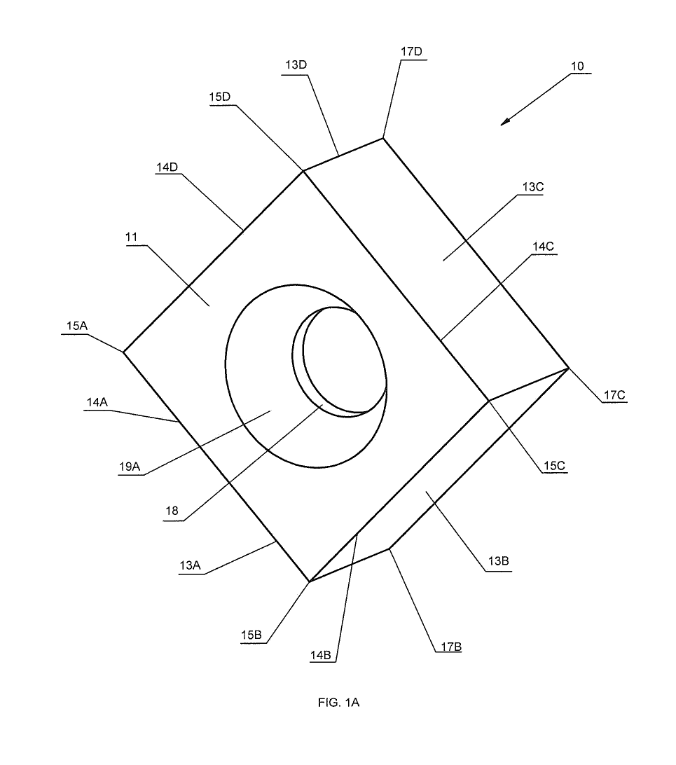

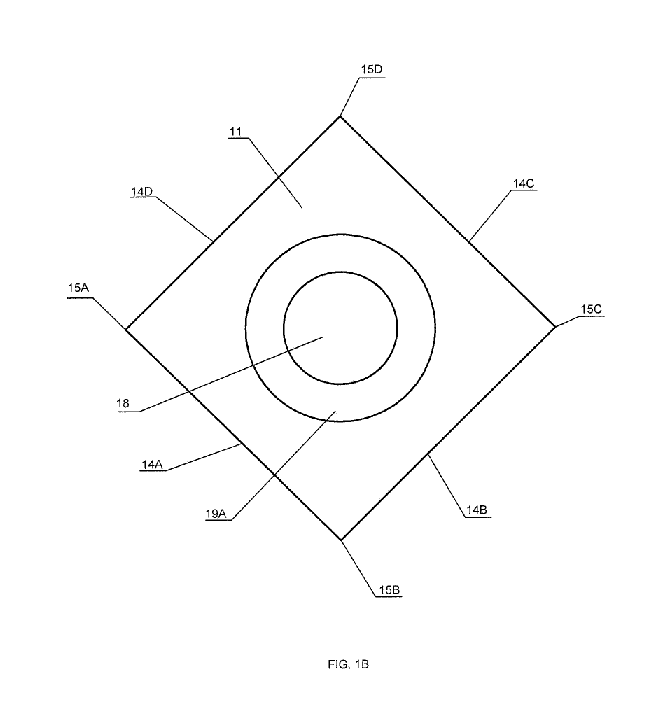

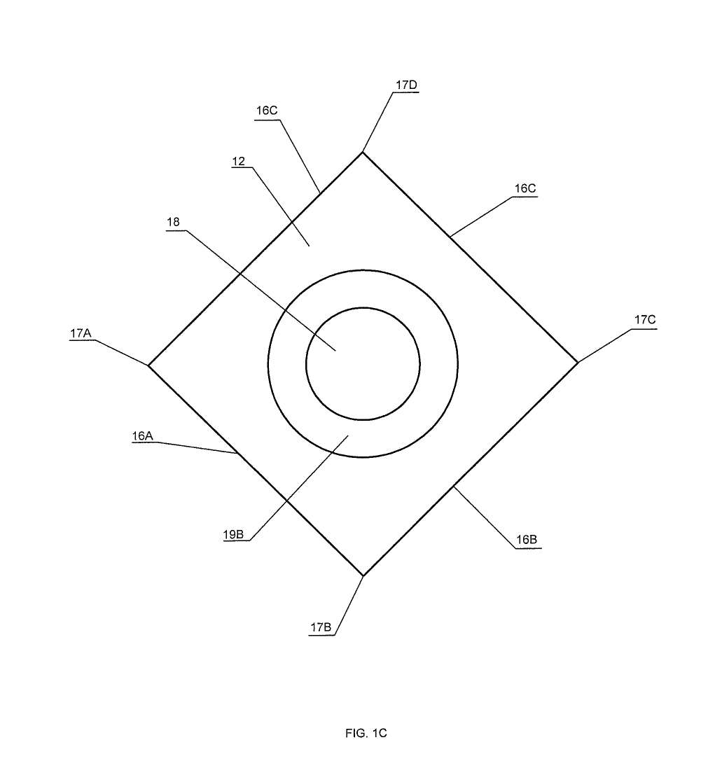

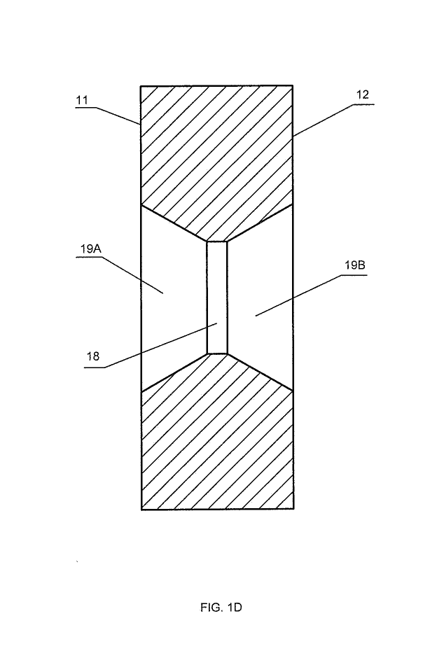

FIGS. 1A-1D show a first embodiment of a knife configured to be used in a tool assembly of the invention in a perspective view FIG. 1A, a front view FIG. 1B, a rear view FIG. 1C and a sectional view FIG. 1D;

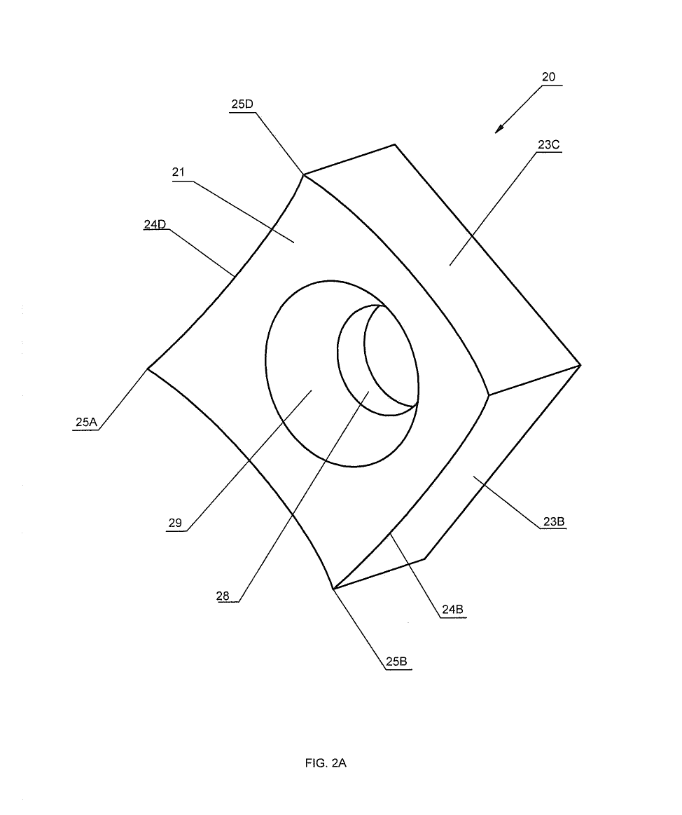

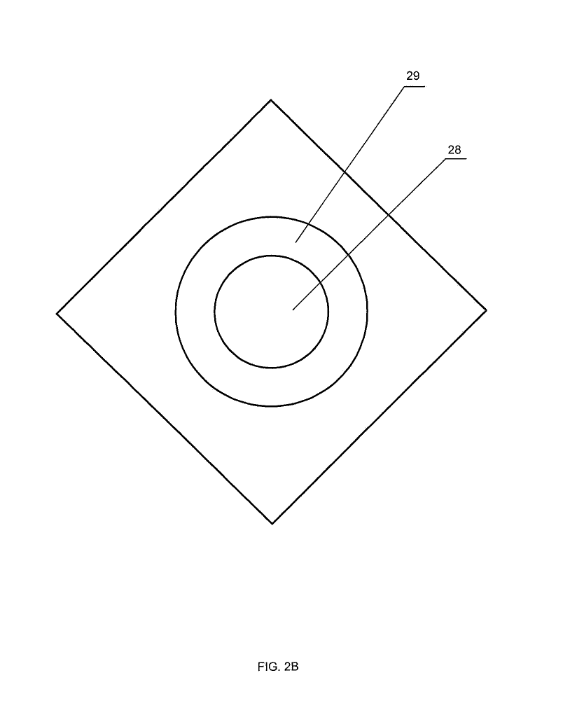

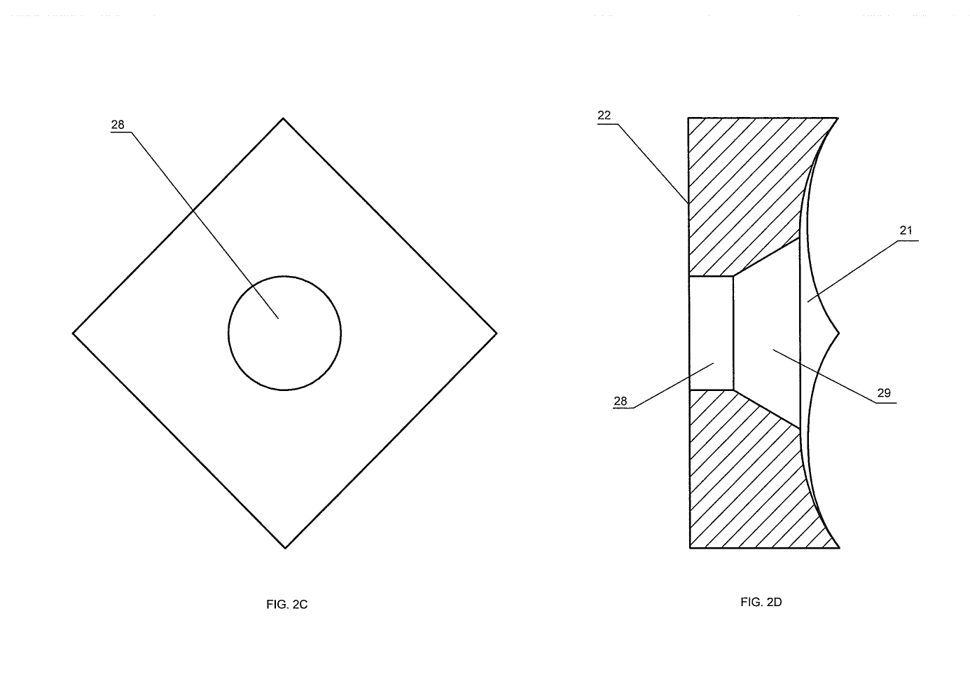

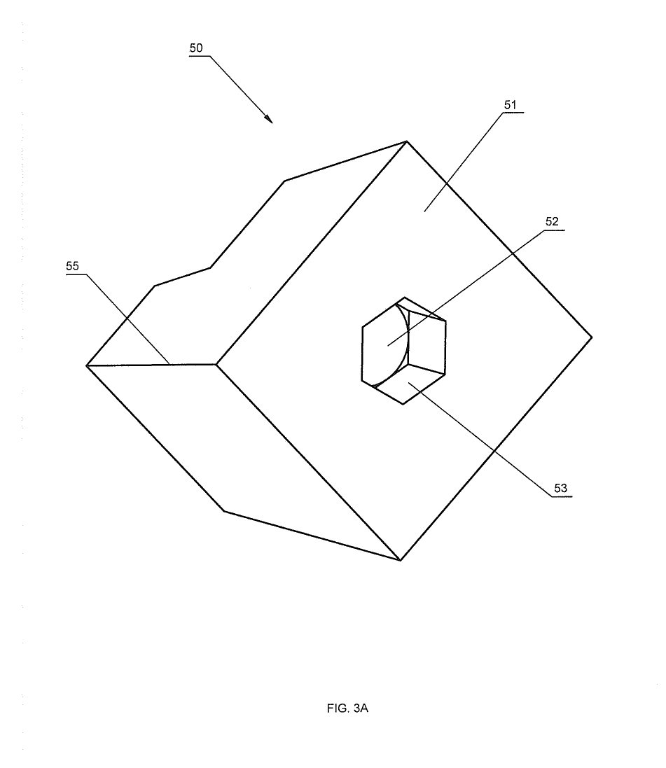

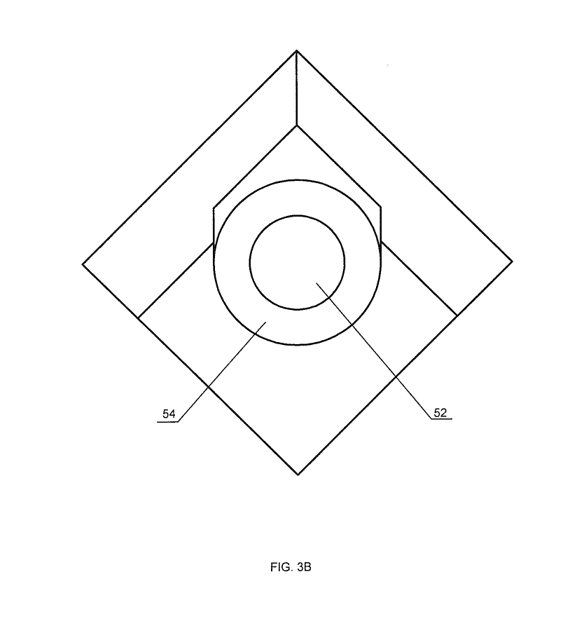

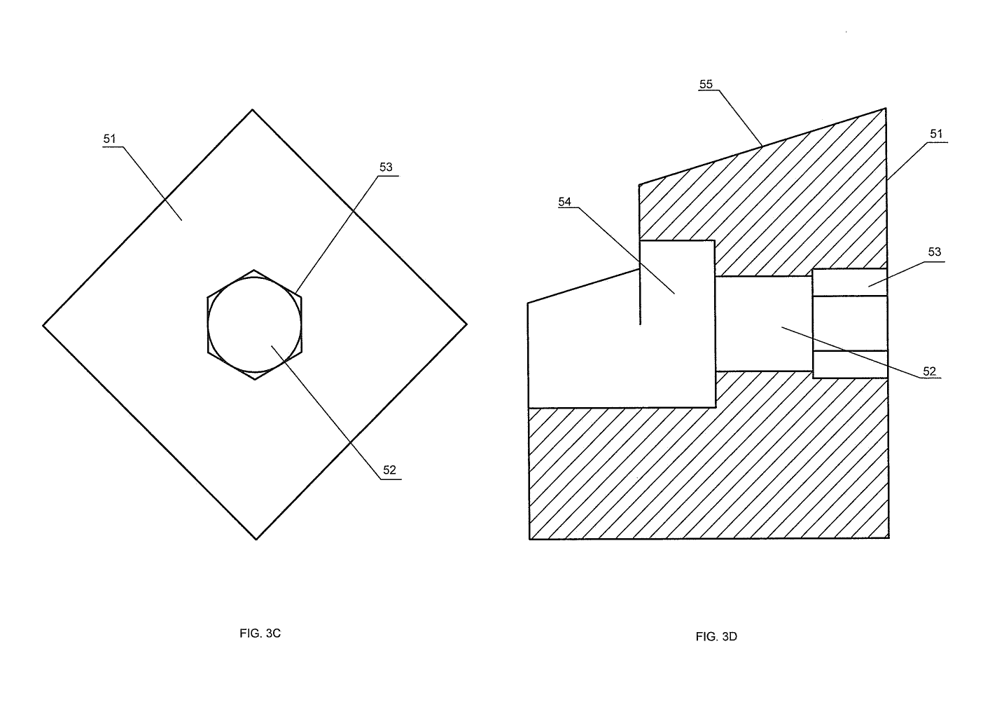

FIGS. 2A-2D show another embodiment of a knife configured to be used in a tool assembly of the invention in a perspective view FIG. 2A, a front view FIG. 2B, a rear view FIG. 2C and a sectional view FIG. 2D;

FIGS. 3A-3D show an embodiment of a knife carrier configured to be used in a tool assembly of the invention for detachably securing a knife according to FIGS. 1-2 to a comminuting rotor of a comminuting apparatus in a perspective view FIG. 3A, a front view FIG. 3B, a rear view FIG. 3C and a sectional view FIG. 3D;

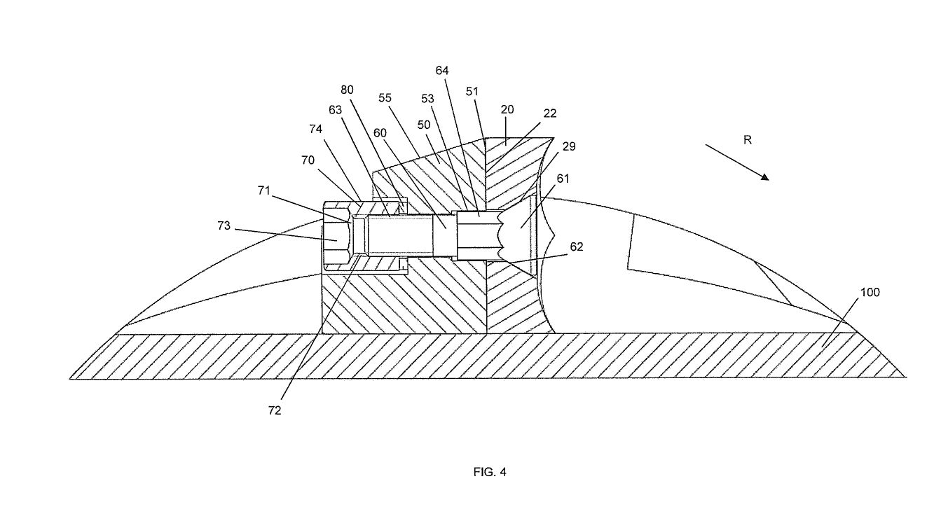

FIG. 4 shows the arrangement of a tool assembly of the invention, comprising a knife carrier according to FIG. 3A to which a knife according to FIG. 2A is detachably secured via a screw connection, on a comminuting rotor in a sectional view;

FIG. 5 shows the arrangement of a tool assembly of the invention, comprising a knife carrier according to FIG. 3A to which a knife according to FIG. 1A is detachably secured via a screw connection, at a comminuting rotor in a sectional view;

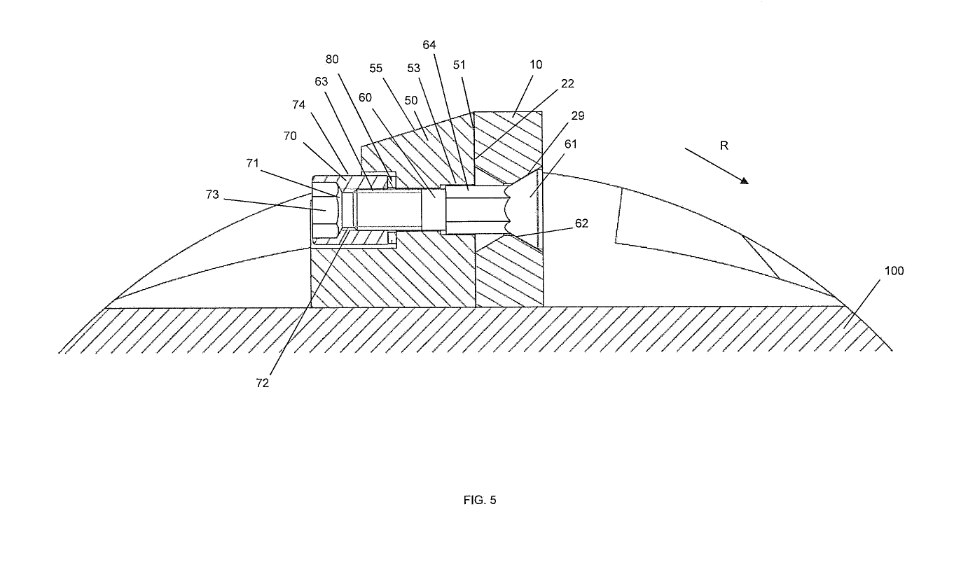

FIG. 6 shows the arrangement of another embodiment of a tool assembly of the invention on a comminuting rotor in a sectional view; and

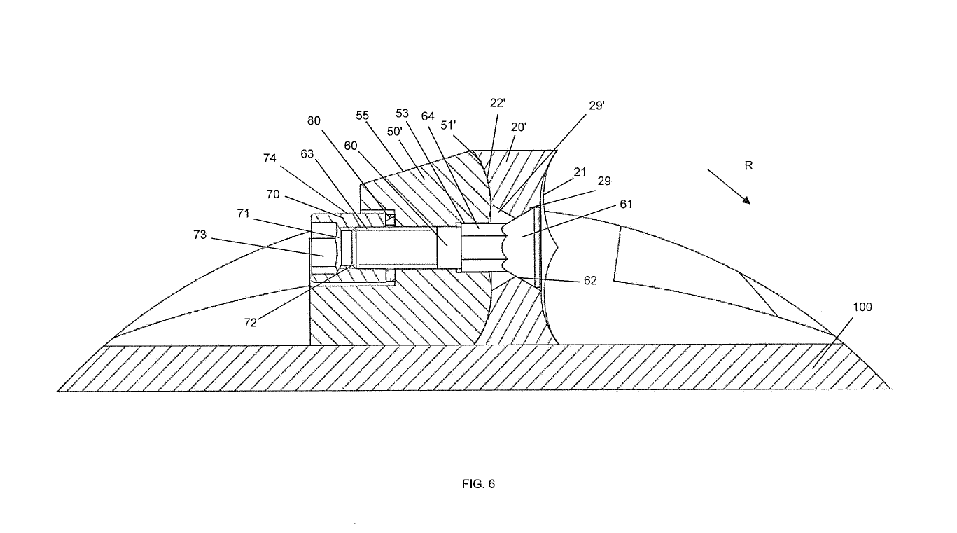

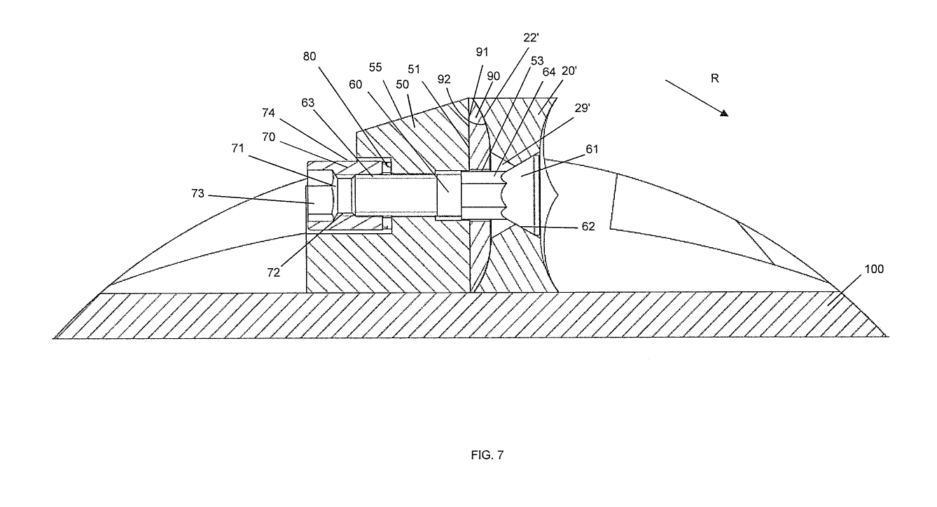

FIG. 7 shows another tool assembly of the invention secured to a comminuting rotor in a sectional view, which comprises an adapter plate in addition to the components of FIGS. 4, 5 and 6.

FIGS. 1A-1D and FIGS. 2A-2D each show an embodiment of a knife for a comminuting apparatus for use in a tool assembly of the invention which may as such be able to be secured to a comminuting rotor, for example using screws or by welding.

In the embodiment described, knife 10 of FIGS. 1A-1D, also known as a cutting crown, is configured as a prism having two bases 11, 12 defined by four cutting edges 14A-14D and 16A-16D, respectively. Respective two of these cutting edges intersect at a cutting tip 15A-15D or 17A-17D. As both bases provide cutting edges, they are herein referred to as working faces. In this embodiment, knife 10 has flat bases 11, 12 and flat lateral faces 13A-13D disposed perpendicularly thereto. For securing the knife, it has a through bore 18 which is smooth on the inside, i.e. does not have a thread. To receive a conical head of a screw bolt, a conical expansion 19A, 19B is provided on both working faces, i.e. on both bases 11, 12. This can best be seen in the sectional view of FIG. 1D showing a section, including the bore axis and extending in parallel to lateral faces 13B and 13D. In this embodiment, both bases are formed as identically configured working faces.

The knife according to FIGS. 2A-2D is first of all different from the knife according to FIG. 1A-1D in that the front base 21 is concavely curved such that two respective concave cutting edges 24A-24D intersect at a respective cutting tip 25A-25D. When the knife is used, these tips engage the material to be comminuted like hooks due to the concave paths of the cutting edges, resulting in an aggressive comminution. Again, the working face, here base 21, has a conical expansion or depression 29 at through bore 28. As a further difference to knife 10 according to FIGS. 1A-1D, rear base 21 of knife 20 is not configured as a working face, therefore not having a depression at bore 28, see FIG. 2C.

In the embodiment described, to detachably secure the knives to the comminuting rotor, a single integral knife carrier 50 is provided for each knife, see FIGS. 3A-3D, FIG. 3A showing the knife carrier in a perspective view, FIG. 3B showing the knife carrier in a front view against the rotor's direction of rotation, FIG. 3C showing a rear view of the knife carrier, and FIG. 3D showing the knife carrier in a sectional plane including the axis of a through bore 52 of the knife carrier and oriented in parallel to the surface normal of abutment face 51.

In the embodiment described, knife carrier 50 is welded into a milled seat at the rotor, wherein the seat may be configured as a V-shaped recess at the rotor. At its rear surface facing away from the knife, knife carrier 50 comprises a, e.g. cylindrical, depression 54 around bore 52. Top boundary face 55 shades the area of depression 54, which will be discussed further below. As can be seen from the front view of FIG. 3B and the sectional view of FIG. 3D, another depression 53 is provided at the front of the knife carrier, i.e. at abutment face 51 at the bore, here having polygonal boundary faces, in particular in the form of a hexagon socket.

FIG. 4 shows a sectional view of the arrangement of a knife 20 as described above which is detachably secured to a knife carrier 50 by a screw connection, the knife carrier being itself welded onto a comminuting rotor 100 of a comminuting apparatus, the sectional plane being perpendicular to the axis of the comminuting rotor and the axis of a through bore 52 (see FIG. 3D) of a knife carrier 50 extending in the sectional plane.

As can be seen from FIG. 4, knife 20 abuts flat abutment face 51 of knife carrier 50 with its rear flat base 22. A screw bolt 60 extends from the knife side across through bore 28 of the knife and through bore 52 of knife carrier 50 and exits therefrom with its threaded portion 63 in the area of depression 54 of knife carrier 50. A screw nut 70 axially closed on one side by an intermediate base portion 71 is screwed onto bolt thread 63 of the screw bolt. Screw nut 70 abuts knife carrier 50 via a split washer 80 to clamp knife 20 to knife carrier 50. Screw bolt 60 has a conical screw head 61 with a circumferential surface 62 which entirely, i.e. over a circumference of 360°, abuts conical expansion 29 of knife 20.

In the embodiment described, adjacent screw head 61, the shaft of screw bolt 60 is configured with a polygonal, here hexagonal, cross section which, when the tool assembly is in its assembled state, extends into the area of positive-fit surfaces 53 of knife carrier 50, see FIG. 3D. The complementarily formed positive-fit surfaces in portion 64 of screw bolt 60 correspond to positive-fit surfaces 53 of knife carrier 50, thus providing a positive fit between the screw bolt and knife carrier which prevents the screw bolt to be turned within knife carrier 50, making it easier to secure and detach the knife to and from the knife carrier.

In the example described, on the side of intermediate base portion 71 of screw nut 70 facing away from thread 72, the nut has tool abutment faces formed as hexagon socket surfaces one of which is indicated by reference number 73 in FIG. 4. External circumferential surface 74 of screw nut 70 protects these tool abutment faces against the impact of material to be comminuted to provide for easy insertion of a corresponding tool, here a hexagon key, to unscrew screw nut 70. Accordingly, top boundary face 55 of knife carrier 50 is further sloped to shadow screw bolt 60 and screw nut 70 in direction of rotation R of the comminuting rotor from the material to be comminuted.

FIG. 5 shows another embodiment of a tool assembly configured according to the invention and secured to a rotor 100 in a sectional view corresponding to the illustration of FIG. 4. The knife is formed identically to knife 10 described above with reference to FIG. 1. The only difference compared to the embodiment shown in FIG. 4 is that knife 10 is not configured to be concave at its working face, but flat like at its abutment face 51.

FIG. 6 shows another embodiment of a tool assembly configured according to the invention and again secured to a rotor 100 in a sectional view corresponding to the illustration of FIG. 4. With respect to base 21, knife 20′ is formed identically to knife 20 described above with reference to FIG. 2. The only difference is the configuration of base 22 which is not flat in this case, but identical to that of base 21. Accordingly, base 22′ is configured as a concave working face with concavely curved cutting edges, respective two of which intersect at a cutting tip. As explained above with reference to base 21, base 22′ also has a conical expansion 29′ in the area of through bore 28, having the same function as the conical expansion 29 of abutment face 21. Complementarily to concave working face 22′ of knife 20′, abutment face 51′ of knife carrier 50′ is configured such that knife 20′ abuts knife carrier 50′ across its entire working face 22′. The further configuration of knife carrier 50′ and knife 20′ corresponds to that of knife carrier 50 and knife 20 of FIG. 4, respectively, and will therefore not be described any further. The configuration of the tool assembly according to FIG. 6 has the advantage that, upon wear of the currently active cutting edge or associated cutting tip, knife 20′ can not only be rotated about the axis of through bore 28 after unscrewing the screw connection to increase service life. In addition, knife 20 can be inverted such that the base initially acting as the abutment face against the knife carrier serves as the working face after inverting the knife. Accordingly, the base of the knife initially used as the working face then abuts the knife carrier.

FIG. 7 shows another configuration of a tool assembly for securing to a rotor 100. What is installed is a knife 20′ which is identical to the knife described with reference to FIG. 6. In addition, knife carrier 50 is structured identically to knife carrier 50 of FIG. 4. In order to provide for an adaptation of flat abutment face 51 to concave base 22′ of knife 20, an adapter plate 90 is provided which has a flat abutment face 91 facing the knife carrier and a curved, here convex, abutment face 92 facing knife 20′. Both in the configuration according to FIG. 6 and that according to FIG. 7, both screw bolt 60 and screw nut 70 are formed identically to those of FIG. 4. The implementation according to FIG. 7 is particularly suitable for such applications in which a comminuting rotor is equipped with non-detachably attached knife carriers 50 which are to be provided with knives that can be used with both sides.

### LIST OF REFERENCE NUMBERS

10 Knife
11, 12 Base
13A-13D Lateral face
14A-14D Cutting edges
15A-15D Cutting tips
16A-16D Cutting edges
17A-17D Cutting tips
18 Through bore
19A, 19B Conical expansion
20, 20′ Knife
21, 22,
22′ Base
23A-23D Lateral face
24A-24D Cutting edge
25A-25D Cutting tip
26A-26D Cutting edge
27A-27D Cutting tip
28 Through bore
29, 29′ Conical expansion
50, 50′ Knife carrier
51, 51′ Abutment face
52 Through bore
53 Positive-fit surface
54 Depression
55 Sloped surface
60 Screw bolt
61 Screw head
62 Conical surface
63 Threaded portion
64 Circumferential positive-fit portion
70 Screw nut
71 Intermediate base portion
72 Thread
73 Tool abutment face
74 External circumferential surface
80 Split washer
90 Adapter plate
91 Flat abutment face
92 Convex abutment face
100 Comminuting rotor
R Direction of rotation

1. A tool assembly for a comminuting apparatus having knives secured to the periphery of a comminuting rotor, comprising:
an integral knife carrier adapted to be secured to the comminuting rotor of the comminuting apparatus, and having a supporting surface for support against a seat formed at the rotor and an abutment face with a non-threaded through bore extending therefrom;
a knife detachably secured to the knife carrier, having at least three lateral boundary faces and two bases, wherein at least one of the two bases is adapted to be a working face having a plurality of cutting edges, and wherein at least two cutting edges intersect at a cutting tip, and wherein the knife has a non-threaded through bore extending between both bases and having a countersink, in particular in the form of a conical expansion, at the working face; wherein the knife directly or indirectly abuts the abutment face of the knife carrier with one of both bases, and the through bore of the knife carrier and the through bore of the knife are aligned to each other;
a screw connection between the knife and knife carrier, comprising a screw bolt extending through the through bores of the knife and the knife carrier with a conical head abutting the countersink of the bore at the working face of the knife, wherein a screw nut is screwed onto a portion of the screw bolt, extending beyond the trough bore of the knife carrier, for clamping the knife to the knife carrier.

2. The tool assembly as claimed in claim 1, characterised in that the working face of the knife is formed concavely to provide curved cutting edges.

3. The tool assembly as claimed in claim 1 or 2, characterised in that the other base of the knife is also adapted to be a working face having a plurality of cutting edges, and respective two cutting edges intersect at a cutting tip, and the bore has a conical expansion at the other base.

4. The tool assembly as claimed in claim 3, characterised in that both working faces of the knife have radii of curvature different from each other.

5. The tool assembly as claimed in any one of claims 1 to 4, characterised in that the screw bolt abuts the knife only with its conical head.

6. The tool assembly as claimed in any one of claims 1 to 5, characterised in that the knife carrier has a cylindrical depression around its through bore at the side facing away from the knife, with at least a portion of the screw nut extending therein.

7. The tool assembly as claimed in any one of claims 1 to 6, characterised in that boundary faces of the knife carrier shadow the threaded end of the screw bolt in the rotor's direction of movement.

8. The tool assembly as claimed in any one of claims 1 to 7, characterised in that a positive-fit anti-rotation mechanism is provided between the shaft of the screw bolt and the knife carrier.

9. The tool assembly as claimed in claim 8, characterised in that the shaft of the screw bolt is formed with positive-fit surfaces in the cross section, in particular polygonal, extending axially over a predetermined distance, and the bore of the knife carrier within this longitudinal portion has complementary positive-fit surfaces, in particular having a complementary polygonal shape, to provide a positive fit between the screw bolt and knife carrier.

10. The tool assembly as claimed in claim 9, characterised in that a key or close tolerance pin is disposed, each extending in a keyway or mating bore, respectively, within the screw bolt and knife carrier.

11. The tool assembly as claimed in any one of claims 1 to 10, characterised in that the screw nut has a sleeve-like base body, having a threaded portion and a tool-engaging portion axially adjacent thereto directly or via an axial connecting portion, wherein the tool-engaging portion has an axial mount for providing tool abutment faces, in particular in the form of a hexagon socket.

12. The tool assembly as claimed in claim 11, characterised in that, between the threaded portion and tool-engaging portion, an intermediate base portion is disposed, extending perpendicularly to the axis of the sleeve-like base body.

13. The tool assembly as claimed in any one of claims 1 to 12, characterised in that, between the knife carrier and knife, an adapter plate is disposed for adapting the abutment face of the knife to the abutment face of the knife carrier.

14. A comminuting rotor for a comminuting apparatus, comprising at least one tool assembly as claimed in any one of claims 1 to 13.

15. A knife for a tool assembly as claimed in any one of claims 1 to 13, wherein the knife has at least three, in particular four, lateral boundary faces and two bases, and wherein at least one of the two bases is adapted to be a working face having a plurality of cutting edges, and at least two cutting edges intersect at a cutting tip, and wherein the knife has a non-threaded through bore extending between both bases and having a countersink, in particular in the form of a conical expansion, at the working face, and the knife is directly or indirectly abuttable against the abutment face of the knife carrier with one of both bases, and the through bore of the knife carrier and the knife are able to be aligned to each other.

16. The knife as claimed in claim 15, characterised in that the working face of the knife is formed concavely to provide curved cutting edges.

17. The knife as claimed in claim 15 or 16, characterised in that the other base of the knife is also adapted to be a working face having a plurality of cutting edges, and respective two cutting edges intersect at a cutting tip, and the through bore also has a countersink at the other base.

18. The knife as claimed in claim 15, 16 or 17, characterised in that the knife comprises a hard metal, in particular being formed as a solid hard metal knife.
